(19) United States
(12) Patent Application Publication
(10) Pub. No.: US 2019/0314681 A1
(43) Pub. Date: Oct. 17, 2019

(54) METHOD, SYSTEM AND COMPUTER PRODUCTS FOR EXERCISE PROGRAM EXCHANGE

(71) Applicant: JIE YANG, NORTH SALEM, NY (US)

(72) Inventor: JIE YANG, NORTH SALEM, NY (US)

(21) Appl. No.: 16/384,097

(22) Filed: Apr. 15, 2019

Related U.S. Application Data
(60) Provisional application No. 62/659,124, filed on Apr. 17, 2018.

(51) Int. Cl. A63B 24/00; G06K 9/62

(52) U.S. Cl. CPC A63B 24/0075; A63B 2024/0081; G06K 9/6267

(57) ABSTRACT

A novel method and apparatus for an exercise program exchange is disclosed. The disclosed method comprises receiving a fitness exercise program from a first device operated by a first user, upon receipt of a request from a second user for access to the fitness exercise program, determining eligibility of the second user to access the fitness exercise program, and upon determining that the second user is eligible to access the fitness exercise program, enabling the second user using at least one of the first device or a second device to access the fitness exercise program.

### RELATED APPLICATIONS

The present application claims the benefit of U.S. Provisional Patent Application No. 62/659,124, entitled “Method for Transfer and Adjustment of Exercise Parameters”, filed on Apr. 17, 2018, which is incorporated herein by reference in its entirety.

### TECHNOLOGY FIELD

This invention relates to fitness technology field, especially related to a method, system and computer products for exercise program exchange.

### BACKGROUND TECHNOLOGY

Fitness exercise program is generally composed of certain exercise parameters, such as speed, incline, distance etc. within a certain time which facilitate user to achieve certain heart rate, to burn certain number of calories or to achieve certain speed, distance, etc.

In reality, the implementation of fitness exercise program is performed independently on an isolated machine, and data exchange between users is generally limited to the exchange of audio files, pictures, videos, texts and exercise status updates, etc., while the exchange of data directly related to fitness exercise programs is very limited. As it stands right now, such limited exchange of data directly related to fitness exercise programs significantly impedes users' ability to maximize the benefit of having access to data provided by an exercise source.

### INVENTION SUMMARY

This disclosure is directed at a method and a system for an exercise program exchange to assist users in maximizing the effectiveness of fitness exercise and to improve users' overall fitness exercise experience.

In order to achieve the said goals, the embodiment of the present invention provides the following technological solutions:

In the preferred embodiment, this disclosure is directed to a method for a fitness exercise program exchange comprising receiving, by a server, a fitness exercise program from a first device operated by a first user, upon receipt of a request from a second user for access to the fitness exercise program, determining, by the server, eligibility of the second user to access the fitness exercise program; and upon determining that the second user is eligible to access the fitness exercise program, enabling, by the server, the second user using at least one of the first device or a second device to access the fitness exercise program, wherein the fitness exercise program comprising a first set of parameters, a second set of parameters, and a third set of parameters, wherein the first set of parameters comprises a plurality of fitness exercise parameters, wherein the second set of parameters comprises a plurality of access permission parameters, wherein the third set of parameters comprises a plurality of program classification identifiers, wherein the plurality of fitness exercise parameters comprises at least one of: speed, pace, incline, distance, time, watt, pound, steps, work, repetitions, calories, and the like, wherein the plurality of access permission parameters comprises at least one of: age of a user, member of members in a group, amount of payment; history of exercise; amount of contribution in exercise resources; user's rank of memberships, user's experiences in certain sports, and the like, wherein the plurality of program classification identifiers comprises at least one of: speed, pace, incline, distance, time, watt, pound, steps, repetitions, work, calories, heart rate, blood pressure, and the like, wherein determining that the second user is eligible to access the fitness exercise program comprises determining whether the request for access satisfies at least one of the second set of parameters.

The method further comprises maintaining an electronic communication with the at least one of the first device or a second device and controlling the use of the at least one of the first device or a second device in accordance with the at least one of the plurality of fitness exercise parameters of the fitness exercise program.

The disclosed method further comprises categorizing the fitness exercise program based on at least one of the plurality of program classification identifiers, wherein a first category of the fitness exercise program comprises a fitness exercise program configured to terminate upon determining that a goal set by at least one of the plurality of fitness exercise parameters is achieved, wherein a second category of the fitness exercise program comprises a fitness exercise program configured to facilitate ability of a user to maintain the at least one the plurality of fitness exercise parameters, and wherein a third category of the fitness exercise program comprises a combination of the first category of the fitness exercise program and the second category of the fitness exercise program.

### SHORT DESCRIPTION OF DRAWINGS

FIG. 1 is a block diagram illustrating the method for exercise programs exchange, according to a first embodiment of the present invention;

FIG. 2 is a block diagram illustrating the method for exercise programs exchange, according to a second embodiment of the present invention;

FIG. 3 is a block diagram illustrating the method for exercise programs exchange, according to a third embodiment of the present invention;

FIG. 4 is a block diagram illustrating the method for exercise programs exchange, according to a fourth embodiment of the present invention;

FIG. 5a is a block diagram illustrating the method for exercise programs exchange, according to a fifth embodiment of the present invention e;

FIG. 5b is a block diagram illustrating the method for exercise programs exchange, according to an embodiment of the present invention;

FIG. 6a is a block diagram illustrating the method for exercise programs exchange, according to an embodiment of the present invention;

FIG. 6b is a block diagram illustrating the method for exercise programs exchange, according to an embodiment of the present invention;

FIG. 7 is a block diagram illustrating the method for exercise programs exchange, according to an embodiment of the present invention; and

FIG. 8 is a block diagram illustrating the method for exercise programs exchange, according to an embodiment of the present invention.

### DETAILED DESCRIPTION

The preferred embodiment of the present invention is implemented as a computational methodology and a software application system for the method of compiling, amending, and sharing fitness exercise data among users.

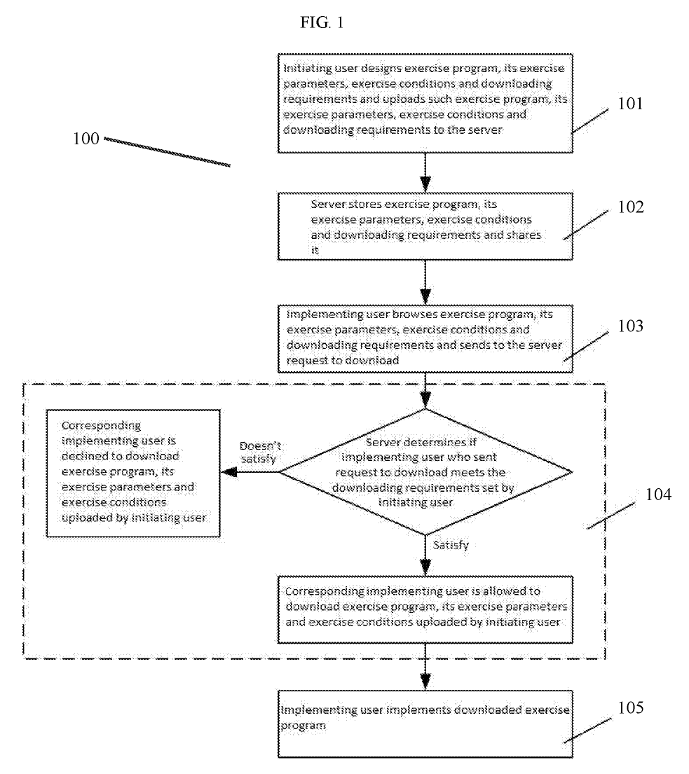

FIG. 1 illustrates the preferred embodiment of the disclosed method. Specifically, method 100 for fitness exercise program exchange comprises step 101 in which a user designs exercise program is initiated, exercise parameters and exercise conditions are set, and requirements for access and use of the exercise program is downloaded to the server.

In step 102, the method 100 causes the server to store the said exercise program, its exercise parameters, exercise conditions and downloading requirements and makes it discoverable by interested users.

In step 103, the method 100 comprises enabling interested users to search for and locate the said exercise program, its exercise parameters, exercise conditions and downloading requirements and enabling interested users to send to the server request for download of said exercise program.

In step 104 of method 100, the said server is configured to determine if one of the interested users meets the downloading requirements set by initiating user. If interested user does meet necessary downloading requirements, then such interested user is allowed to access and/or download the said exercise program, its exercise parameters and exercise conditions uploaded by initiating user. If interested user does not meet necessary downloading requirements, then said interested user is denied the request to access and/or to download exercise program, its exercise parameters and exercise conditions uploaded by initiating user.

Finally, in step 105 of the method 100, interested user who meets downloading requirements is directed to access and/or to download the exercise program.

Using the method for exercise program exchange, when implementing user meets downloading requirements set by initiating user, the server shares the exercise program, its exercise parameters and exercise conditions with the implementing user, then the implementing user is able to implement exercise program according to exercise parameters and exercise conditions set by initiating user, thus the user performs exchange of exercise program via server, increasing communication between users and providing user with more benefits from exercise source, thus improving user's overall experience.

When implementing the said method for exercise program exchange, in Step 101, the initiating user may upload to the server his/her exercise program, the exercise program's exercise parameters, exercise conditions and downloading requirements through the initiating user's terminal.

In more details, through the server socket the server can monitor user socket, through user socket initiating user sends to the server request to connect, the server connects to initiating user user's socket through Server Socket and establishes Short-term connection route TCP (transmission control protocol), using TCP/IP the initiating user's socket sends to the server exercise program, including exercise parameters, exercise conditions and downloading requirements which he/she wants to upload. In Step 102, the method 100 causes the server to store the exercise program and makes it public, or makes it searchable, to provide implementing user with chance to browse and download.

At this point the said server TCP and the initiating user's socket disconnect and communication is deemed completed.

In Step 103, the method comprises enabling the implementing user to establish short-term TCP connection between implementing user's socket and server to browse the exercise programs, the exercise program's exercise parameters, exercise conditions and downloading requirements stored on the server and to send downloading request to the server.

In Step 104, the method 100 comprises enabling the server to determine if the implementing user meets the downloading requirements designed by initiating user, if he/she does, then the short-term TCP connection between implementing user's socket and server turns into long-term TCP connection. For example, heartbeats protocol can be used to avoid overload on server CPU and server collapse during long-term TCP connection between server and multiple users. If he/she doesn't meet the requirements, then the short-term TCP connection between implementing users socket and server gets disconnected, and communication ends.

It is to be understood that in the disclosed method the downloading requirements can be set by initiating user. For example, the initiating user may set the completion of payment as downloading requirement, so after the implementing user completes the payment, he can download exercise program, the exercise parameters and exercise conditions. Of course, the downloading requirements can also be certain types of contribution or achievement, or when the contribution or achievement value reaches some certain levels, such as uploading certain amounts of specific exercise programs, completion of certain amount of competitions or burning certain amount of calories in certain periods of time, etc.

In the disclosed method for exercise program exchange, the so-called exercise program means a series of exercise movements based on a series of exercise parameters which are connected using certain sequence, implementing the said exercise program is to reach certain exercise goals, for example, run a certain period of time at certain variable speeds, cover a certain amount of mileage with different inclines for certain periods of time at certain speed, etc.; the so-called exercise conditions mean the defined states or ways the implementing user have to follow or satisfy while implementing the designed exercise program, for example maintain heart rate at a certain range, keep blood pressure below a certain level, run at a speed no faster than a certain value, make step per mins no less than a certain rate, etc.; “exercise parameters” are those numbers that implementing user has to entry into the exercise equipment to adjust the working status of the said exercise equipment, or those numbers to quantify certain physical movements or loads of the implementing user, these parameters can be used to represent or determine user's exercise status data and goals. Typical exercise parameters may include speed, incline, magnetic resistance, watt, pounds, distance or time, etc. The so-called exercise status data of implementing user is represented as numerical values of the exercise state of the implementing user while implementing the designed exercise program, for example, the speed of the implementing user is 9 mph, the force the implementing user exerting is 40 N, or the heart rate of the implementing user is 99 bpm.

As the implementing user's physical movement status on exercise equipment can be measured through the exercise parameters of the exercise equipment, the exercise parameters of the exercise equipment can directly represent the physical status of implementing users, for example, a runner running on a treadmill with the belt is running at 9 mph, the 9 mph can be used for the runner's running speed as the exercise status data of speed. But for certain physiological status of implementing user, the exercise equipment or exercise movement itself may not be able to directly represent but can indirectly influence the value, for example, an implementing user's heart rate cannot be changed directly by the treadmill or 5 lbs weight, but can be indirectly increased or decreased by adjusting running speed or incline or the rate of moving the weight.

In summary, when certain exercise parameters can represent or determine certain exercise status data of the implementing user, these said certain exercise parameters are called the condition-related exercise parameters of the said certain exercise status data, where exercise parameters determine completion of exercise program (Category 1) or condition-related exercise parameters, where exercise parameters represent the implementing user's exercise status data or determine implementing user's exercise status data during implementation of the exercise program (Category 2).

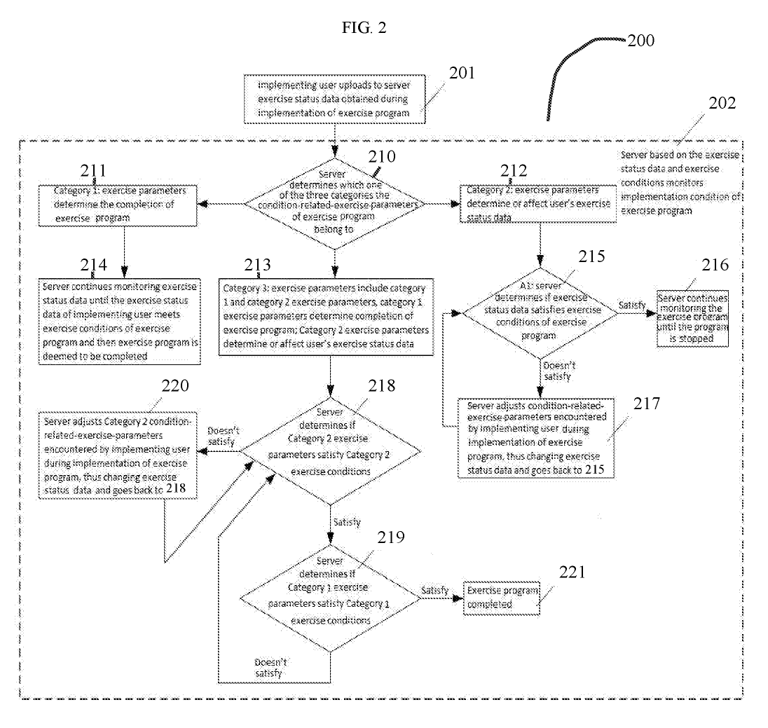

FIG. 2 illustrates an embodiment of the method for exercise program exchange, following the step 105.

Specifically, FIG. 2 illustrates method 200 which is invoked when a user is enabled for a download of the exercise program. In step 201, an implementing user uploads to the server exercise status data obtained during implementation of exercise program. It is important to note that the “upload” in this context means uploading in real time, server receives user's exercise status data in certain time periods. Besides, the said “exercise status data” means real-time numerical values of body physical and physiological state obtained during/after implementation of exercise program, such as speed, incline, blood pressure and heart rate, etc.

In step 202 the said server is configured to monitor the said implementing user's exercise status based on the exercise status data and exercise conditions.

In some embodiments of this invention as shown in FIG. 2, the server is configured to be able to adjust condition-related exercise parameters and to change exercise status data produced by implementing user to make exercise status data satisfy exercise conditions set in exercise program.

In details, step 202 comprises the following logical steps:

Server is configured to determine which one of three categories the condition-related exercise parameters of exercise program belong to:

Category 1, identified in step 211: exercise parameters determine completion of exercise program. Exercise parameters in this category can be considered as final goal of exercise performed by the implementing user, once the goal is reached, the exercise can be deemed completed. Such category parameters may be distance, resistance, calorie burn, time, or even physiological values like heart rate, etc. If the exercise parameters of exercise program belong to Category 1, then, in step 214, the said server is configured to continue monitoring the said exercise status data of the implementing user until the said exercise status data of the implementing user satisfies the said exercise conditions of the said exercise program and completes the said exercise program after that.

For example, a runner wants to complete 1 mile on the treadmill at certain speed and incline. The exercise condition of the exercise program here is the completion of exercise program when the distance reaches 1 mile. So, when the runner implements such program and reaches the distance of 1 mile, then such program is deemed to be completed.

Category 2, identified in step 212: exercise parameters represent the implementing user's exercise status data or determine implementing user's exercise status data during implementation of the exercise program, for example, the set exercise status may be moving speed, incline, resistance, blood pressure and heart rate, etc., in which the said speed, incline and resistance can represent the implementing user's physical status, while the implementing user's blood pressure and heart rate will be adjusted by the said user's physical status like moving speed, incline and force etc.

If it is determined that the exercise parameters of exercise program belong to Category 2, then, in step 215, the said server is configured to determine if the said implementing exercise status data of the said implementing user satisfies the said exercise conditions of the said exercise program;

if the said implementing exercise status data of the said implementing user satisfies the said exercise conditions, in step 216, the said server is configured to continue monitoring the exercise status of the implementing user until the said exercise program is completed by the said implementing user.

However, if the said implementing exercise status data of the said implementing user does not satisfy the said exercise conditions, in step 217, the said server is configured to adjust the Category 2 condition-related exercise parameters encountered by the implementing user during implementation of the said exercise program to change the said exercise status data, and return to step 215.

For example, on treadmill, a certain running program consists of three exercise conditions of targeted heart rate within 100-110 bpm and incline at 5% and the adjustable exercise parameter of speed. The exercise status data in this program is the actual time of the implementing user exercising and actual speed the implementing user experiencing and 5% incline and actual heart rate. Because the incline and heart rate are defined, the speed of the treadmill will be the only one exercise parameter to be adjusted to change the heart rate. When the implementing user is running at 9 mph which he/she changed manually, his/her actual heart rate is 120 bpm which is higher than the upper limit of 110, so the said server will decrease the implementing user's running speed to decrease his/her heart rate from 120 bpm to 110 bpm at certain time intervals; on the contrary, when the implementing user is running at 6 mph which he/she changed manually, his/her heart rate is 90 bpm which is lower than the lower-limit of 100 bpm, so the server increases the speed to increase his/her heart rate to 100 bpm at certain time intervals. In another example similar to the example mentioned above, the speed on the treadmill can be preprogrammed with variable values at certain timeframe, so when the speed of the treadmill automatically reaches 9 mph as preprogrammed, the implementing user's actual heart rate is 120 bpm which is higher than the upper limit of 110, then the said server will decrease the treadmill's speed to decrease his/her heart rate from 120 bpm to 110 bpm at certain intervals; on the contrary, when the treadmill's speed reaches at 6 mph automatically as preprogrammed, the implementing user's heart rate is 90 bpm which is lower than the lower limit of 100 bpm, so the server increases the treadmill speed to increase the implementing user's heart rate to 100 bpm. This procedure will last till the implementing user stops the exercise program. Thus, this method for exercise program exchange can help implementing user to achieve training goals with variable exercise conditions, simultaneously providing standardization and assistance in exercise, reducing the risk of occurrence of abnormal situation during exercise and providing convenience so that user could focus on their goals.

Category 3, identified in step 213: exercise parameters include the exercise parameters of Category 1 (described in step 211) and Category 2 (described in step 211). Category 1 exercise parameters determine completion of exercise program, while Category 2 exercise parameters represent the implementing user's exercise status data or determine implementing user's exercise status data during implementing the exercise program.

If the said exercise parameters of the exercise program are associated with Category 3, then:

In step 218 the server is configured to determine whether the Category 2-related exercise status data provided by the implementing user satisfies the Category 2-related exercise conditions of the said exercise program.

If the said Category 2-related exercise status data does not satisfy the Category 2-related exercise conditions, then, in step 220, the said server is configured to adjust the said Category 2 condition-related exercise parameters encountered by the implementing user during implementation of the said exercise program to change the said exercise status data of the implementing user, and return to step 218.

If the said Category 2-related exercise status data does satisfy the said Category 2-related exercise conditions of the said exercise program, then, in step 219, the said server is configured to determine whether the Category 1-related exercise status data of the said implementing user satisfies the said Category 1-related exercise conditions of the said exercise program.

If, in step 219, the said Category 1-related exercise status data of the said implementing user satisfies Category 1 exercise conditions of the said exercise program, then the exercise program is deemed completed in step 221.

If, in step 219, the said Category 1-related exercise status data of the said implementing user does not satisfy the said Category 1 related exercise conditions, then the said server is configured to continue monitoring the said exercise status data of the said implementing user and returns control to step 218.

For example, on treadmill, a certain exercise program consists of 30 minutes jogging with three exercise conditions of heart rate within 100-110 bpm and maximum incline of 5% and the adjustable exercise parameter of speed. The exercise status data in this program is the actual time of the implementing user exercising and actual speed and incline the implementing user experiencing and actual heart rate. Because the heart rate range is defined, the speed and limited incline levels will be the two exercise parameters to be adjusted to change the heart rate. When the implementing user is running at 9 mph and 5% incline which he/she changed manually, his/her actual heart rate is 120 bpm which is higher than the upper limit of 110, so the said server will decrease the implementing user's running speed and/or incline levels to decrease his/her heart rate from 120 bpm to 110 bpm at certain time intervals; on the contrary, when the implementing user is running at 6 mph and 3% incline which he/she changed manually, his/her heart rate is 90 bpm which is lower than the lower-limit of 100 bpm, so the server increases the speed and/or incline to increase his/her heart rate to 100 bpm at certain time intervals. It should be noted that the speed will become the only one exercise parameter to be adjusted once the incline reaches 5% due to the defined condition of maximus incline level of 5%. When the heart rate is within 100-110 bpm and the incline level is no more than 5%, then the said server will check if the time of the Category 1 reaches 30 mins: when the time elapsed is less than 30 mins, then the said server will continue monitoring the exercise status and change the speed and incline accordingly as mentioned above; when the time reaches 30 mins, then the exercise program is deemed completed and the treadmill stops. In another example similar to the example mentioned above, the speed and incline levels on the treadmill can be preprogrammed with variable values in 30 minutes, so when the speed of the treadmill reaches 9 mph and/or 5% incline automatically as preprogrammed, the implementing user's actual heart rate is 120 bpm which is higher than the upper limit of 110, then the said server will decrease the treadmill's speed and/or incline to decrease his/her heart rate from 120 bpm to 110 bpm at certain time intervals; on the contrary, when the treadmill's speed reaches 6 mph and 3% incline automatically as preprogrammed, the implementing user's heart rate is 90 bpm which is lower than the lower limit of 100 bpm, so the server increases the treadmill speed and/or incline to increase the implementing user's heart rate to 100 bpm at certain time intervals. It should be noted that the speed will become the only one exercise parameter to be adjusted when the incline is preprogramed at 5% due to the defined condition of maximum incline level of 5%. When the heart rate is within 100-110 bpm and the incline level is no more than 5%, then the said server will check if the elapsed time which belongs to the Category 1 exercise parameters reaches 30 mins: when the time elapsed is less than 30 mins, then the said server will continue monitoring the exercise status and change the speed and incline accordingly as mentioned above; when the time reaches 30 mins, then the exercise program is deemed completed and the treadmill stops. Thus, the said method for exercise exchange programs may help user to reach certain training goals with variable exercise conditions, at the same time providing implementing user with assistance and norms, thus decreasing risks of abnormal situations and increasing exercise safety and convenience.

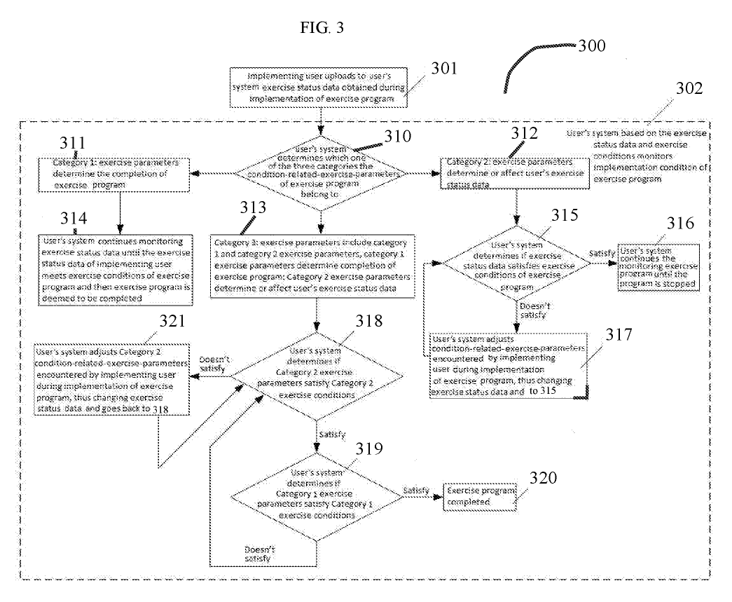

In another embodiment of this invention, illustrated in FIG. 3, following step 105 of FIG. 1, the disclosed method for exercise program comprises the following logical steps:

In step 301, the system is configured to enable the implementing user to save to the user's system all exercise status data obtained during/after implementation of the exercise program. Among them, user's system means user's terminal local system, “exercise status data” means real-time numerical values of body physical and physiological states obtained during/after implementation of the exercise program, such as moving speed, incline, force, watt, heart rate and blood pressure, and the like.

In step 302 the said user's system is configured to monitor the said implementing user's exercise status based on the exercise status data of the implementing user and exercise conditions of the said exercise program.

Being a realistic method, as shown in FIG. 3, the user's system is configured to adjust exercise parameters of the exercise program, thus changing exercise status data obtained by implementing user to make its exercise status data satisfy exercise conditions set in exercise program. In details, the above-mentioned sub-process 302 discloses the steps of determining to which category the condition-related exercise parameters of exercise program belongs.

Specifically, in step 310 a determination is made about the association of the exercise program with at least one category based on the condition-related exercise parameters.

Category 1, identified in step 311: exercise parameters determine completion of exercise program. Exercise parameters in this category can be considered as final goal of exercise of implementing user, once the goal is reached, the exercise can be deemed completed. Such category parameters may be distance, resistance, calorie burn, time, or even physiological values like heart rate and blood pressure, etc. If the exercise parameters of exercise program belong to Category 1, then, in step 314, the said local system is configured to continue monitoring the said exercise status of the implementing user until the said exercise status data of the implementing user satisfies the said exercise conditions of the said exercise program and, subsequently, completes the said exercise program.

Category 2, identified in step 312: exercise parameters represents or determines user's exercise status data, so the exercise parameters of the exercise program can directly or indirectly affect exercise status data of implementing user, such set exercise parameters may be speed, incline, force, magnetic resistance and others.

If exercise parameters of exercise program belong to Category 2, then the following steps will be performed:

In step 315, the said local system is configured to determine whether the said implementing exercise status data of the said implementing user satisfies the said exercise conditions of the said exercise program.

If the said implementing exercise status data of the said implementing user satisfies the said exercise conditions of the said exercise program, then, in step 316, the said local system is configured to continue monitoring the exercise status of the implementing user until the said exercise program is completed by the said implementing user.

Conversely, if the said implementing exercise status data of the said implementing user does not satisfy the said exercise conditions of the said exercise program, then, in step 317, the said local system is configured to adjust the Category 2 condition-related exercise parameters encountered by the implementing user during implementation of the said exercise program to change the said exercise status data, and, then, return control to step 315.

Category 3, identified in step 313: exercise parameters include the exercise parameters of Category 1 and 2. Category 1 exercise parameters determine completion of exercise program, while Category 2 exercise parameters represent the implementing user's exercise status data or determine implementing user's exercise status data during implementation of the exercise program.

If the said exercise parameters of the exercise program is associated with Category 3, then:

In step 318, the said local system is configured to determine whether the said

Category 2 related exercise status data of the said implementing user satisfies the said Category 2 related exercise conditions of the said exercise program;

If the said Category 2-related exercise status data does not satisfy the Category 2-related exercise conditions, then, in step 321, the said local system is configured to adjust the said Category 2 condition-related exercise parameters encountered by the implementing user during implementation of the said exercise program, to change the said exercise status data of the implementing user, and return control to step 318.

Conversely, if the said Category 2-related exercise status data satisfies the said Category 2-related exercise conditions set in the said exercise program, then, in step 319, the said local system is configured to determine whether the Category 1-related exercise status data of the said implementing user satisfies the said Category 1-related exercise conditions of the said exercise program.

If, in step 319, it is determined that the said Category 1-related exercise status data of the said implementing user satisfies Category 1 exercise conditions of the said exercise program, then, in step 320, the exercise program is deemed completed.

Conversely, if in step 319 it is determined that the said Category 1-related exercise status data of the said implementing user does not satisfy Category 1 exercise conditions of the said exercise program, then the said local system is configured to continue monitoring the said exercise status data of the said implementing user and return control to step 318.

Based on the exercise status data provided by the implementing user and exercise conditions of the exercise program, the local system is able to adjust the condition-related exercise parameters of exercise program thus enabling implementing user to reach a certain training goals and at the same time providing implementing user with assistance and normalization of exercise thus decreasing risks of any abnormal situation during exercise and increasing the exercise safety.

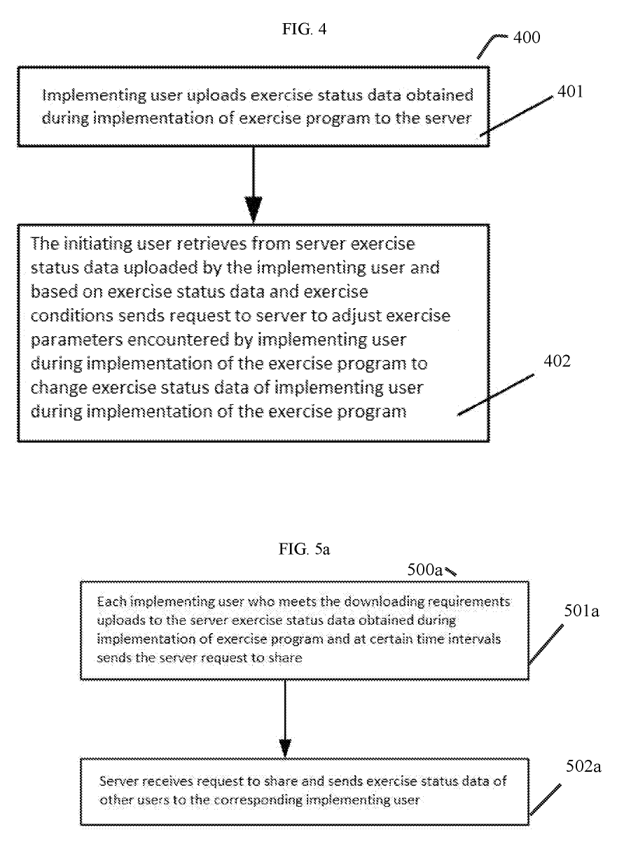

As illustrated in FIG. 4, in some other embodiments of the disclosed invention, for an exercise program, it's possible to use exercise parameters adjusted by another user thus changing exercise status data of implementing user so that implementing user could be under guidance and management of initiating user making the exercise to be safer and more streamlined.

Specifically, following step 105 of FIG. 1, the disclosed method for exercise program exchange also includes the following steps:

In step 401, the disclosed system is configured to implement user uploads exercise status data obtained during implementation of exercise program to the server.

Subsequently, in step 402, the disclosed system is configured to initiate user downloads from the server the exercise status data uploaded by implementing user and based on exercise status data and exercise conditions of the said exercise program and to send request to adjust condition-related exercise parameters encountered during implementation of the exercise program by corresponding implementing user to change corresponding exercise status data provided by implementing user during implementation of the said exercise program.

In some embodiments of the disclosed invention, in the said method for exercise program exchange, there may be more than one implementing user who satisfies downloading requirements, following step 105 in FIG. 1.

For example, as illustrated in FIG. 5a, in step 501a, each implementing user, who satisfies downloading requirements after implementation of the downloaded exercise program, is enabled to upload exercise status data to the server and, after a certain period of time, send to the server request to share, then, in step 502a, the server is configured to respond to the request to share, and to send exercise status data uploaded by other users to the corresponding user.

In an alternative embodiment, illustrated in FIG. 5b, in step 501b, the system is configured to enable every implementing user satisfying downloading requirements to upload to the server exercise status data obtained during/after implementation of the downloaded exercise program, and, in step 502b, then the system is configured to enable the server, at certain period of time, automatically, to initiate distribution of exercise status data to all implementing users who satisfy downloading requirements.

For example, an initiating user sets an exercise program of 10,000-meter run as well as downloading requirements, many implementing users who meet the downloading requirements download the said program and participate simultaneously or half-way, so implementing users who participate in the said exercise program may upload exercise status data to the server in real time and in real time acquire other exercise status data of other implementing users during implementation of this exercise program. This exercise program doesn't have any restrictions on place, time or participants number, facilitating users from different places to participate in the said exercise program and letting them share their own exercise status data in real time, at the same time they can familiarize themselves with exercise status data of other implementing users, resulting in real time exercise exchange, which increases exercise related communication between users and increases users enthusiasm for the exercise, thus improving user's overall experience.

Besides, in the above-mentioned embodiment, the said process of exercise status data exchange may be performed in such a way that either the server shares the exercise status data in respond to the requests from the implementing users or the server initiates sharing automatically at certain time intervals.

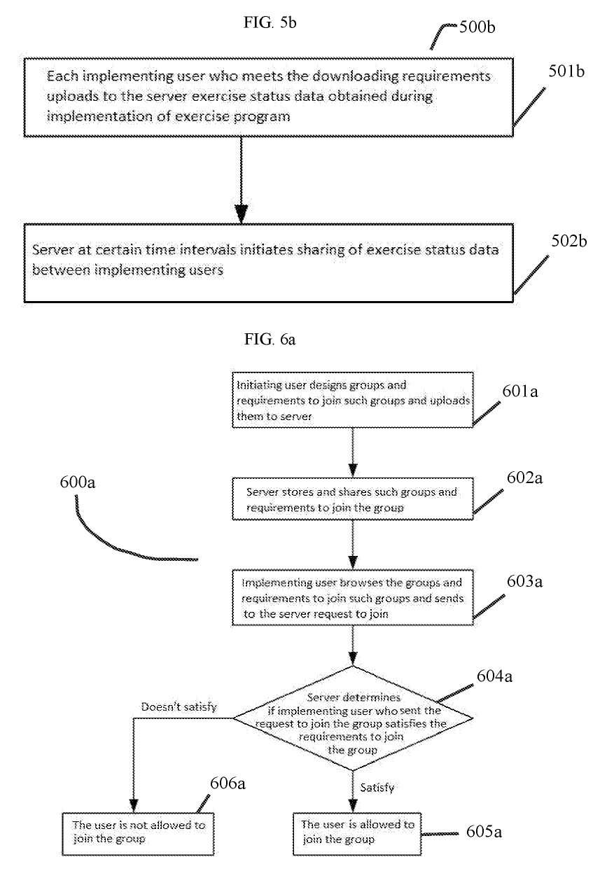

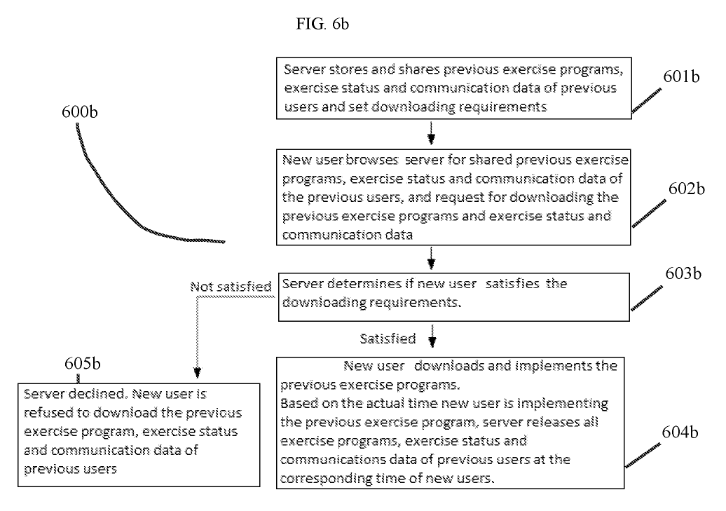

As illustrated in FIG. 6a, in some embodiments of the disclosed invention, the disclosed method for exercise program exchange comprises: step 601a at which the initiating user is enabled to set group and necessary requirements to join the group and to upload said necessary requirements to the server. At step 602a, the server is configured to store and shares group and requirements necessary for users to meet in order to join the group. At step 603a, the system is configured to enable implementing users to browse available groups and requirements necessary to join the group and to send to the server a request to join the group. At step 604a, the server is configured to determine whether implementing user, who sends the request to join the group, satisfies requirements to join the group. If in step 604a, it is determined that a prospective user does satisfy the necessary requirements to join the group, in step 605a, the prospective user is enabled to join the corresponding group. If, however, in step 604a, it is determined that a prospective user does not satisfy the necessary requirements to join the group, then, in step 606a, the prospective user is denied the user's request to join the corresponding group.

The requirements to join the group may be determined by initiating user, so the user could create the exercise groups based on his own interests and likes, which promotes sharing, communication and support between users.

In the above-mentioned embodiment, the above mentioned method may also include: implementing users who already joined the group upload to the server exercise programs and exercise status data obtained during/after implementation of the exercise program; server shares the exercise programs and exercise status data between implementing users who already joined the group.

As illustrated in FIG. 6b, in some embodiments of the present invention, the disclosed method and system of exercise program exchange also comprises: step 601b, at which, in accordance with a predetermined parameters, the server is configured to store and to share previous exercise programs, exercise status data of previous users of said exercise program obtained during implementation of such said previous exercise program and communication data between these said previous users and sets downloading requirements for download. At step 602b, a new user is enabled to browse the database communicatively connected to the server to search for shared previous exercise programs, exercise status data of the said previous users obtained during implementation of such said previous exercise programs and communication data between the said previous users. At step 603b, upon detecting the new user's request to download the said previous exercise programs, the server is configured to determine whether the new user satisfies the downloading requirements. If, at step 603b, it is determined that the new user satisfies the downloading requirements, at step 604b, the server is configured to allow the new user to download the said previous exercise programs, exercise status data and communication data, and to enable the new user to download the said previous exercise programs, exercise status data and communication data. Based on the actual time when the said new user is implementing the said previous exercise program, the said server is configured to release all exercise programs, exercise status data and communications data which previous users had at the corresponding time. If, however, it is determined that the new user does not satisfy the downloading requirements, at step 605b, the said server is configured to deny the new user's request for downloading.

For example, a certain previous exercise program is a running competition with set distance of 10,000 meters, it has 100 implementing users (previous users) who participated and uploaded their exercise status data and communication data to the server, and the said exercise status data and communication data are recorded based on the time of the running event, and the downloading condition is set as giving permission to download for those who answer “Yes” to the question of if he/she runs minimum 5 miles a week regularly and giving rejection for downloading to those who answer “No” to the question of if he/she runs minimum 5 miles a week regularly. Another implementing user (new user) browses this exercise program and send a request to join this program, after he/she answered “yes” to the question given by the server, he/she can download and implement the said previous exercise program. At the same time based on new user's actual time of implementing this exercise program, the previous 100 implementing user's exercise status data and communication data is replayed at the corresponding time of the new user. This provides new users with exercise status data of previous users as reference and previous communication data to strengthen exercise related communication between new and previous users. If he/she answered “No” to the question given by the server, then he/she is refused to download.

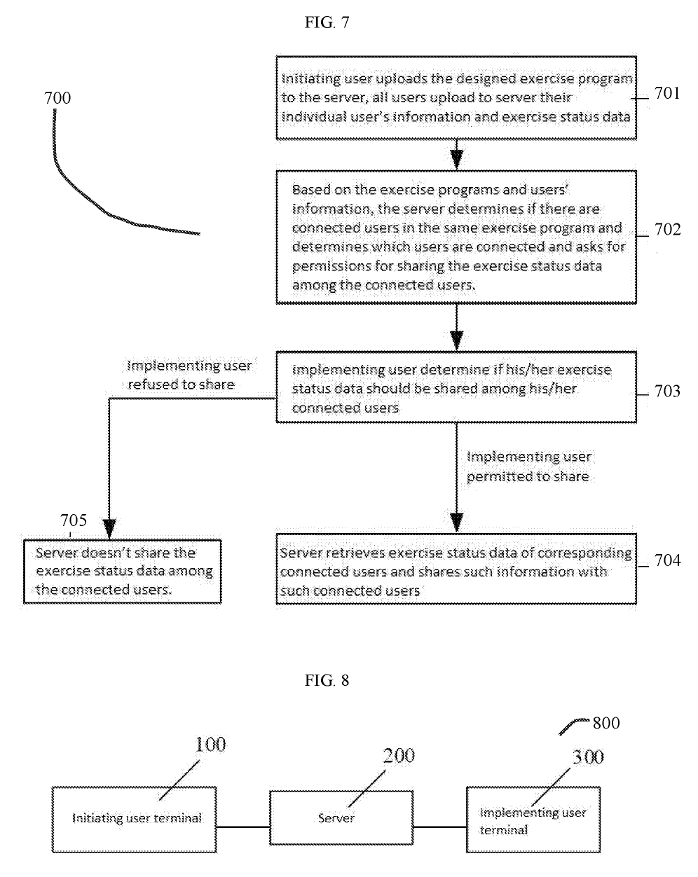

In a few embodiments of this invention, as illustrated in FIG. 7, the above-mentioned method and system for exercise program exchange also comprises the following steps:

In step 701, one or more initiating users is enabled to upload to the server the designed exercise program to the server, along with their individual user's information and exercise status data, and all implementing users upload to server their individual user's information and exercise status data.

In step 702, based on the uploaded exercise programs and users' information, the server is configured to determine whether there are connected users in the exercise program and to determine which users are connected and requests permission from the implementing user who has connections to share the exercise status data between the implementing user and other connected users; connected users should at least satisfy one condition: be at same group, be friends or participate in the same exercise program.

In step 703, the implementing user is enabled to determine whether his/her exercise status data may be shared between the implementing user and other connected users.

If in step 703, it is determined that the implementing user refuses to share the implementing user's exercise status data, then, in step 705, the server is configured not to share the exercise status data between the implementing user and other connected users.

Alternatively, if in step 703, it is determined that the implementing user permissions to share the implementing user's exercise status data, then, in step 704 the server is configured to retrieve the implementing user's exercise status data and to share such information among such connected users.

In the above mentioned embodiment, the server based on the designed exercise program in which the implementing users are using and implementing users' information determine if there is connection between users.

For example, an initiating user published an indoor marathon running event with certain exercise conditions and downloading requirements. User is asked to give permission to share his exercise status data with all other users who joined this program in order to use this program. Once server received the permission from the user, his exercise status data will be shared with all other users who are doing this program; if the user refused to share with other users, then his exercise status data will not be shared with other users. In another example, 100 users joined an exercise program online, server found 80 users are actually running this program, and among the 80 users there are 20 users shared at least 1 exercise group and 32 users have friends, then the server requests the permissions to share the exercise status data from these 20 users who shared groups with others and the 32 users who have friends. Typical permission request may be “John is in this program and from your Running group, do you want to share your status data with him” or “Your friends Jack and Jim are here, do you want to share your status with them?” For those users who gave permissions to share, the server will share the exercise status data to those same group members or friends; if permission request is refused, then the server doesn't share the exercise status data with his/her connected users.

In another embodiment of this invention, as illustrated in FIG. 8, provided is a method and system for exercise program exchange which includes the step of: initiating user terminal (step 100) where the system is configured to design exercise program and set exercise parameters and exercise conditions and download requirements for such program and upload exercise program, its exercise parameters, exercise conditions and downloading requirements to the server; storing exercise program on the server (step 200), along with its exercise parameters, exercise conditions and download requirements, uploaded by initiating user terminal 100, wherein the server is configured to share such information; and implementing user terminal (step 300), enabling browsing of exercise programs, the programs' exercise parameters, exercise conditions and downloading requirements, shared by the server in response to a download request received by the server.

It is to be understood that the server of FIG. 8 is also configured to be used to determine whether the implementing user terminal 300, from which the downloading request was originated meets download requirements set by initiating user terminal. If it is determined that the implementing user terminal meets download requirements, then the corresponding implementing user terminal is configured to allow the download of the exercise program, exercise parameters and exercise conditions uploaded by initiating user terminal; if it is determined that the implementing user terminal does not meet download requirements, then the implementing user terminal is configured to decline a request to download exercise program, its exercise parameters and exercise conditions uploaded by initiating user terminal. It is to be understood that implementing user terminal is also configured to download from the server the exercise program and its exercise parameters and exercise conditions and to implement the downloaded exercise program.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud computing system. In such a network-based cloud computing system, a server or another processor that is connected to a network communicates with one or more client computers via a network.

A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer. The server may also transmit data adapted to cause a client computer to perform a specified function, e.g., to perform a calculation, to display specified data on a screen, etc.

For example, the server may transmit a request adapted to cause a client computer to perform one or more of the method steps described herein, including one or more of the steps of FIGS. 1-8. Certain steps of the methods described herein, including one or more of the steps of FIGS. 1-8, may be performed by a server or by another processor in a network-based cloud-computing system. Certain steps of the methods described herein, including one or more of the steps of FIGS. 1-8, may be performed by a client computer in a network-based cloud computing system. The steps of the methods described herein, including one or more of the steps of FIGS. 1-8, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIGS. 1-8, may be implemented using one or more computer programs that are executable by such a processor.

A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

An exemplary computer system may be used to implement systems, apparatus and methods described herein. Said computer system comprises a processor operatively coupled to a data storage device and a memory. Processor controls the overall operation of computer by executing computer program instructions that define such operations.

The computer program instructions may be stored in data storage device, or other computer readable medium, and loaded into memory when execution of the computer program instructions is desired. Thus, the method steps of FIGS. 1-8 can be defined by the computer program instructions stored in memory and/or data storage device and controlled by the processor executing the computer program instructions.

For example, the computer program instructions can be implemented as computer executable code programmed by one skilled in the art to perform an algorithm defined by the method steps of FIGS. 1-8. Accordingly, by executing the computer program instructions, the processor executes an algorithm defined by the method steps of FIGS. 1-8.

Computer system also includes one or more network interfaces for communicating with other devices via a network. Computer also includes one or more input/output devices that enable user interaction with computer system (e.g., display, keyboard, mouse, speakers, buttons, etc.).

Processor may include both general and special purpose microprocessors and may be the sole processor or one of multiple processors of computer system. Processor may comprise one or more central processing units (CPUs), for example. Processor, data storage device, and/or memory may include, be supplemented by, or incorporated in, one or more application-specific integrated circuits (ASICs) and/or one or more field programmable gate arrays (FPGAs).

Data storage device and memory each comprise a tangible non-transitory computer readable storage medium. Data storage device, and memory, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices may include peripherals, such as a printer, scanner, display screen, etc. For example, input/output devices may include a display device such as a cathode ray tube (CRT) or liquid crystal display (LCD) monitor for displaying information to the user, a keyboard, and a pointing device such as a mouse or a trackball by which the user can provide input to computer system.

Any or all of the systems and apparatus discussed herein may be implemented using a computer such as computer system discussed herein.

One skilled in the art will recognize that an implementation of an actual computer or computer system may have other structures and may contain other components as well, and that the computer system described herein is a high-level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

FIGS. 1 through 8 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention.

In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

Further, it will be apparent to those of ordinary skill in the art that methods disclosed herein may be embodied in a computer program product that includes one or more computer readable media. For example, a computer readable medium can include a readable memory device, such as a hard drive device, CD-ROM, a DVD-ROM, and the like, having computer readable program code segments stored thereon. The computer readable medium can also include a communications or transmission medium, such as, a bus or a communication link, either optical, wired or wireless having program code segments carried thereon as digital or analog data signals.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

1. A method comprising:
receiving, by a server, a fitness exercise program from a first device operated by a first user;
upon receipt of a request from a second user for access to the fitness exercise program, determining, by the server, eligibility of the second user to access the fitness exercise program; and
upon determining that the second user is eligible to access the fitness exercise program, enabling, by the server, the second user using at least one of the first device or a second device to access the fitness exercise program.

2. The method of claim 1, wherein the fitness exercise program comprising a first set of parameters, a second set of parameters, and a third set of parameters.

3. The method of claim 2, wherein the first set of parameters comprises a plurality of fitness exercise parameters, wherein the second set of parameters comprises a plurality of access permission parameters, wherein the third set of parameters comprises a plurality of program classification identifiers.

4. The method of claim 3, wherein the plurality of fitness exercise parameters comprises at least one of:
speed; pace; incline; distance; time; watt; pound; steps; repetitions; and calories.

5. The method of claim 3, wherein the plurality of access permission parameters comprises at least one of:
user's age; membership in a group; amount of payment; history of exercise; degree of contribution in exercise resources; rank of membership; experiences level in sports.

6. The method of claim 3, wherein the plurality of program classification identifiers comprises at least one of:
speed; incline; distance; time; watt; pound; steps; repetitions; work; calories; heart rate; blood pressure.

7. The method of claim 1, wherein determining that the second user is eligible to access the fitness exercise program:
determining whether the request for access satisfies at least one of the second set of parameters.

8. The method of claim 1, further comprising:
categorizing the fitness exercise program based on at least one of the plurality of program classification identifiers, wherein a first category of the fitness exercise program comprises a fitness exercise program configured to terminate upon determining that a goal set by at least one of the plurality of fitness exercise parameters is achieved, wherein a second category of the fitness exercise program comprises a fitness exercise program configured to facilitate ability of a user to maintain the at least one the plurality of fitness exercise parameters, and wherein a third category of the fitness exercise program comprises a combination of the first category of the fitness exercise program and the second category of the fitness exercise program.

9. The method of claim 1, further comprising:
maintaining an electronic communication with the at least one of the first device or a second device; and
controlling the use of the at least one of the first device or a second device in accordance with the at least one of the plurality of fitness exercise parameters of the fitness exercise program.

10. An apparatus comprising:
a processor; and
a memory to store computer program instructions, the computer program instructions when executed on the processor cause the processor to perform operations comprising:
receiving a fitness exercise program from a first device operated by a first user;
upon receipt of a request from a second user for access to the fitness exercise program, determining eligibility of the second user to access the fitness exercise program; and
upon determining that the second user is eligible to access the fitness exercise program, enabling the second user using at least one of the first device or a second device to access the fitness exercise program.

11. The apparatus of claim 10, wherein the fitness exercise program comprising a first set of parameters, a second set of parameters, and a third set of parameters.

12. The apparatus of claim 11, wherein the first set of parameters comprises a plurality of fitness exercise parameters, wherein the second set of parameters comprises a plurality of access permission parameters, wherein the third set of parameters comprises a plurality of program classification identifiers.

13. The apparatus of claim 11, wherein: the plurality of fitness exercise parameters comprises at least one of: speed, pace, incline, distance, time, watt, pound, weight, steps, repetitions, and calories; wherein the plurality of access permission parameters comprises at least one of: users' age, membership in a group, amount of payment, history of exercise, degree of contribution in exercise resources, rank of membership, experiences level in sports; and wherein the plurality of program classification identifiers comprises at least one of: speed; incline, distance, time, watt, pound, steps, repetitions, work, calories, heart rate, blood pressure.

14. The apparatus of claim 10, the computer program instructions when executed on the processor cause the processor to perform operations further comprising:
categorizing the fitness exercise program based on at least one of the plurality of program classification identifiers, wherein a first category of the fitness exercise program comprises a fitness exercise program configured to terminate upon determining that a goal set by at least one of the plurality of fitness exercise parameters is achieved, wherein a second category of the fitness exercise program comprises a fitness exercise program configured to facilitate ability of a user to maintain the at least one the plurality of fitness exercise parameters, and wherein a third category of the fitness exercise program comprises a combination of the first category of the fitness exercise program and the second category of the fitness exercise program.

15. A non-transitory computer readable medium having program instructions stored thereon, that in response to execution by a computing device cause the computing device to perform operations comprising:
receiving a fitness exercise program from a first device operated by a first user;
upon receipt of a request from a second user for access to the fitness exercise program, determining eligibility of the second user to access the fitness exercise program; and
upon determining that the second user is eligible to access the fitness exercise program, enabling the second user using at least one of the first device or a second device to access the fitness exercise program.

16. The non-transitory computer readable medium of claim 15, wherein the fitness exercise program comprising a first set of parameters, a second set of parameters, and a third set of parameters.

17. The non-transitory computer readable medium of claim 16, wherein the first set of parameters comprises a plurality of fitness exercise parameters, wherein the second set of parameters comprises a plurality of access permission parameters, wherein the third set of parameters comprises a plurality of program classification identifiers.

18. The non-transitory computer readable medium of claim 16, wherein: the plurality of fitness exercise parameters comprises at least one of: speed, pace, incline, distance, time, watt, pound, weight, steps, repetitions, and calories; wherein the plurality of access permission parameters comprises at least one of: users' age, membership in a group, amount of payment, history of exercise, degree of contribution in exercise resources, rank of membership, experiences level in sports; and wherein the plurality of program classification identifiers comprises at least one of: speed; incline, distance, time, watt, pound, steps, repetitions, work, calories, heart rate, blood pressure.

19. The non-transitory computer readable medium of claim 15, the computer program instructions when executed on the processor cause the processor to perform operations further comprising:
categorizing the fitness exercise program based on at least one of the plurality of program classification identifiers, wherein a first category of the fitness exercise program comprises a fitness exercise program configured to terminate upon determining that a goal set by at least one of the plurality of fitness exercise parameters is achieved, wherein a second category of the fitness exercise program comprises a fitness exercise program configured to facilitate ability of a user to maintain the at least one the plurality of fitness exercise parameters, and wherein a third category of the fitness exercise program comprises a combination of the first category of the fitness exercise program and the second category of the fitness exercise program.

20. A non-transitory computer readable medium having program instructions stored thereon, that in response to execution by a computing device cause the computing device to perform operations comprising:
receiving a fitness exercise program from a first device operated by a first user;
upon receipt of a request from a second user for access to the fitness exercise program, determining eligibility of the second user to access the fitness exercise program; and upon determining that the second user is eligible to access the fitness exercise program, enabling the second user using at least one of the first device or a second device to access the fitness exercise program;
categorizing the fitness exercise program based on at least one of the plurality of program classification identifiers, wherein a first category of the fitness exercise program comprises a fitness exercise program configured to terminate upon determining that a goal set by at least one of the plurality of fitness exercise parameters is achieved, wherein a second category of the fitness exercise program comprises a fitness exercise program configured to facilitate ability of a user to maintain the at least one the plurality of fitness exercise parameters, and wherein a third category of the fitness exercise program comprises a combination of the first category of the fitness exercise program and the second category of the fitness exercise program;
maintaining an electronic communication with the at least one of the first device or a second device; and
controlling the use of the at least one of the first device or a second device in accordance with the at least one of the plurality of fitness exercise parameters of the fitness exercise program.
